(19) United States
(12) Patent Application Publication
(10) Pub. No.: US 2006/0125746 A1
(43) Pub. Date: Jun. 15, 2006

(54) Microelectrical device

(76) Inventors: Jean-Michel Sallese, Pully (CH); Paul Muralt, Ecublens (CH); Didier Bouvet, Morges (CH)

Correspondence Address: STURM & FIX LLP, 206 SIXTH AVENUE, SUITE 1213, DES MOINES, IA, 50309-4076, US

(21) Appl. No.: 11/295,322

(22) Filed: Dec. 6, 2005

Related U.S. Application Data
(60) Provisional application No. 60/635,538, filed on Dec. 13, 2004.

(51) Int. Cl. G09G 3/34

(52) U.S. Cl. 345/85

(57) ABSTRACT

A microelectrical device has a ferroelectric layer (10) between parallel electrodes (20,21) at least one of which (21) is movable. The electrodes have a closed position in which the ferroelectric layer (10) is sandwiched between the two electrodes (21,21) and an open position in which the movable electrode (21) is spaced from the ferroelectric layer (10). A spring effect biases the movable electrode (21) towards the open position. When the movable electrode (21) is closed by a first voltage pulse (P1) the ferroelectric layer (10) is polarized to hold the movable electrode (21) closed. When zero voltage is applied the movable electrode (21) is held closed by remnant polarization of the ferroelectric material until the application of a second voltage pulse (P2) which cancels the remnant polarization of the ferroelectric material (10) to allow the movable electrode(s) to be moved to the open position by the spring effect.

### TECHNICAL FIELD

This invention relates to microelectrical devices in particular those known as MEMS or Micro-Electro-Mechanical Systems. It proposes a novel microelectrical device which can be used inter alia as switchable capacitor, as actuator for the actuation of an electrical devices, such as electrical DC or RF switches and capacitors, as position actuator for optical (micro) mirrors and (micro) shutters, as tunable capacitor in the closed mode when a DC voltage is superimposed to the signal, or as RF switch.

### BACKGROUND ART

During the past few years there has been considerable interest in switch and RF MEMS since they represent a very interesting alternative to conventional microelectronic devices where high quality factors and ideal electrical contacts are required. In addition, a major advantage of MEMS structures is that they can be designed and fabricated by techniques similar to those of large-scale integration of silicon technology. An overview of such devices with a detailed description of the various approaches can be found in: J. J. Yao, RF MEMS from a device perspective, J. Micromech. Microeng. 10 (2000) R9-R38; G. Rebeiz, J. B. Muldavin, RF MEMS switches and switch circuits, IEEE Microwave Mag. 2 (2001) 59-71.

A conventional MEMS structure comprises a dielectric layer disposed between two generally parallel electrodes at least one of which is movable, forming a parallel capacitor structure.

Bistable microrelays with mechanical bistability are known, for example thermally actuated bistable microrelays with a flexible mechanically-bistable double beam that can carry currents up to several amperes when closed, stand off voltages up to several hundreds of volts when open and that switch between their closed and open states in milliseconds (Jin Qiu, et. al. “A Curved-Beam Bistable Mechanism”, Journal of MEMS, vol. 13, no. 2, pp. 137, 2004; Jin Qiu et. al. “A high-current electrothermal bistable MEMS relay”, in Proceeding of the MEMS conference, pp. 64-67, 2003 and L. Que, et. al. “A bi-stable electro-thermal RF switch for high power applications”, in Proc. IEEE MEMS 2004 Conference, pp. 797-800). Magnetically actuated bistable microrelays are also known, but these require an actuating coil and the application of high currents (C. Dieppedale et. al. “Magnetic bistable micro-actuator with integrated permanent magnets”, in Proceedings of IEEE Sensors, vol. 1, pp. 493-496, 2004 and H. Rostaing, et. al. “Magnetic, out-of-plane, totaly integrated bistable micro actuator”, in Proceedings of the 13th International Conference on Solid-State Sensors, Actuators and Microsystems, vol. 2, pp. 1366-1370, 2005).

There is however a need for such structures that have lower power consumption and that have improved switching performance.

### SUMMARY OF THE INVENTION

The invention provides a microelectrical device comprising a ferroelectric layer disposed between two generally parallel electrodes at least one of which is movable. The electrodes have a closed position in which the ferroelectric layer is sandwiched between the two electrodes and an open position in which the or each movable electrode is spaced from the ferroelectric layer by a gap. The movable electrode(s) is biased towards the open position by a spring effect. The electrodes are connectable to a voltage source for applying: a first voltage pulse to move the movable electrode(s) from the open to the closed position against the action of the biasing means, a low or zero voltage, and a second voltage pulse of opposite polarity to the first voltage pulse. When the or each movable electrode is moved to the closed position by the application of a first voltage pulse the ferroelectric layer is polarized to hold the movable electrode(s) against the ferroelectric layer, and when the low or zero voltage is applied the or each movable electrode is held in the closed position by remnant polarization of the ferroelectric material until the application of the second voltage pulse which cancels the remnant polarization of the ferroelectric material to allow the movable electrode(s) to be moved to the open position by the action of the biasing means.

The invention thus provides a ferroelectric MEMS or Micro-Electro-Mechanical System that consists in two electrodes that can move with respect to one another, with a ferroelectric layer in-between.

The distance between the electrodes can be modified by applying a voltage whose effect is to create an attractive electrostatic force between the conductive electrode plates. The ferroelectric MEMS of the invention can be used as a variable capacitor or as a switch.

The role of the ferroelectric layer is to introduce a memory effect through the hysteresis that characterizes ferroelectric materials. Charges created on the electrodes after applying a certain potential will remain even after the potential has dropped to zero. As a consequence it is possible to maintain a certain amount of electrical charge on the electrodes that in turn will generate an attractive force that will keep the electrodes in contact with the ferroelectric layer. By reversing the polarization, it is then possible to cancel the charges on the electrodes that will separate. Under special conditions, this open configuration will also be stable at zero applied voltage.

Thus the device can be put in two stable states without any applied voltage (in the stable states).

Further details of the inventive device and its operation are given in the article “Switch and rf ferroelectric MEMS: a new concept”, co-authored by J-M. Sallese, an inventor of the present invention, published in Sensors and Actuators A 109 (2004) 186-194, and whose contents are incorporated herein by way of reference.

A discussion of ferroelectric materials that have already been used in other MEMS devices and that are usable in the device according to the invention is given in the Article “Ferroelectric thin films for micro-sensors and actuators; a review” by P. Muralt, J. Micromech. Microeng. 10 (2000) 136-146.

The device according to the invention has the following advantages:

It has low power consumption.

It provides reconfigurable switch matrices.

The “On” capacitance is very high compared to conventional MEMS because of the high ferroelectric dielectric constant.

The electric field in the ferroelectric insulator is much lower than in common dielectrics. This in turn reduces the injection of charges in the insulator that may be responsible for undesirable sticking.

The active area can be different from the region where the ferroelectric layer is located.

The device can be used as an actuator with hysteresis in its displacement, e.g. for actuation of micromirrors of a display device.

### BRIEF DESCRIPTION OF DRAWINGS

The invention will be further described by way of example with reference to the accompanying drawings in which:

FIGS. 1A and 1B are schematic representations of a device according to the invention respectively in its open and its closed position;

FIG. 2 is a diagram illustrating the application of voltage pulses to a device according to the invention, with an indication of the corresponding position of the device and the resulting capacitance field;

FIG. 3 schematically illustrates the ferroelectric hysteresis loop of a device according to the invention compared to a standard ferroelectric loop; and

FIG. 4 is a schematic diagram illustrating the structure of a device according to the invention produced by integrated silicon technology.

### DETAILED DESCRIPTION

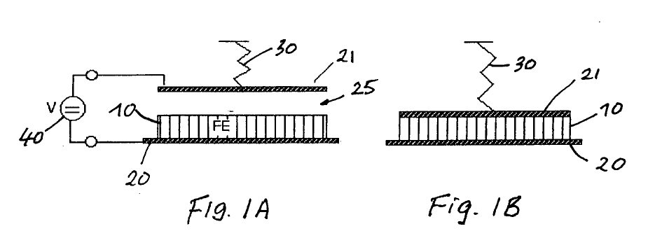

FIGS. 1A and 1B schematically illustrate a microelectrical device according to the invention comprising a ferroelectric layer 10 disposed between two generally parallel electrodes 20, 21, electrode 20 being fixed to the ferroelectric layer 10 and electrode 21 being movable. The electrodes 20,21 have a closed position (FIG. 1A) in which the ferroelectric layer 10 is sandwiched between the two electrodes 21,22 and an open position (FIG. 1B) in which the movable electrode 21 is spaced from the ferroelectric layer 10 by an air (or vacuum) gap 15. A spring 30 or like means biases the movable electrode 21 towards the open position. The electrodes are shown connected to a voltage source 40 for applying a voltage to the electrodes 20,21.

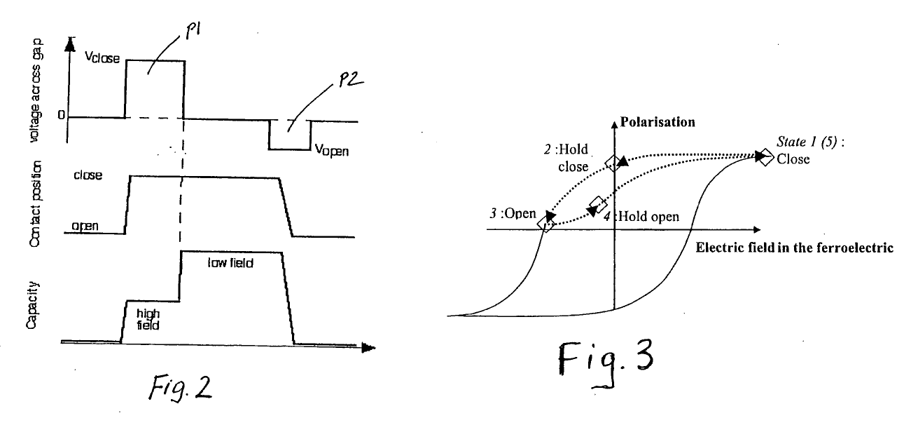

As shown in FIG. 2, the voltage source 40 can apply to the electrodes 20,21 a first voltage pulse P1 to move the movable electrode 21 from the open to the closed position against the action of spring 30, then a low or zero voltage, and a second voltage pulse P2 of opposite polarity to the first voltage pulse P1. When the movable electrode 21 is moved to the closed position by the application of the first voltage pulse P1 the ferroelectric layer 10 is polarized with a high field to hold the movable electrode 21 against the ferroelectric layer 10. Then when the zero voltage is applied the movable electrode 21 is held in the closed position by remnant polarization of the ferroelectric material 10 (which creates a low field) until the application of the second voltage pulse P2 which cancels the remnant polarization of the ferroelectric material 10 to allow the movable electrode 21 to be moved to the open position by the action of the spring 30.

The microdevice shown in FIG. 1 has a parallel capacitor structure, of which at least one of the electrodes 20,21 is movable and held in position by a biasing means (30), and which comprises a ferroelectric layer 10 between the electrodes 20,21. The device is actuated by the Maxwell force to close the air or vacuum gap(s) 25 by an applied voltage pulse P1 (see FIG. 2) in such a way that the ferroelectric material 10 is polarized. When the voltage is decreased to zero, the polarization remains in its remanent state which keeps the compensating charges in the electrodes 20,21. These electrodes provide the necessary electrostatic (or Maxwell) force to keep the microdevice closed. The opening of the device is achieved by a suitable voltage pulse P2 of opposite polarity (see FIG. 2) in order to switch the polarization to almost zero, thus liberating the charges on the electrodes 20,21, and the movable electrode 21 flips back due to the elastic pulling force of the biasing means (spring 30) which can be established in a resilient structure holding the movable electrode 21. This device exhibits bistable operation characteristics as depicted in FIG. 2, because it can remain at rest in its closed or its open position without applying a voltage, i.e. voltage pulses need only be applied to make the device change state from open to closed or closed to open.

FIG. 3 schematically illustrates the difference between the ferroelectric hysteresis loop of a device according to the invention (shown by a dotted line) and a standard ferroelectric loop (shown mainly in a full line). Initially, the layer 10 of ferroelectric material is set into saturation, corresponding to state 1, by the application of an electric field. In this state the device is closed. Decreasing the electric field in the ferroelectric layer 10 leads to the hold-closed state 2 which is stable at zero applied voltage. The open configuration is achieved under proper polarisation in state 3. The open configuration can still be a stable state under zero applied potential: state 4. The closed configuration is recovered at state 5 (identical to state 1) under proper polarization, i.e. by the application of a voltage pulse. It can thus be seen that, in contrast to the ordinary ferroelectric loop, the polarization of the ferroelectric layer of the device according to the invention is not reversed, but stays within zero and saturation polarization of one polarity.

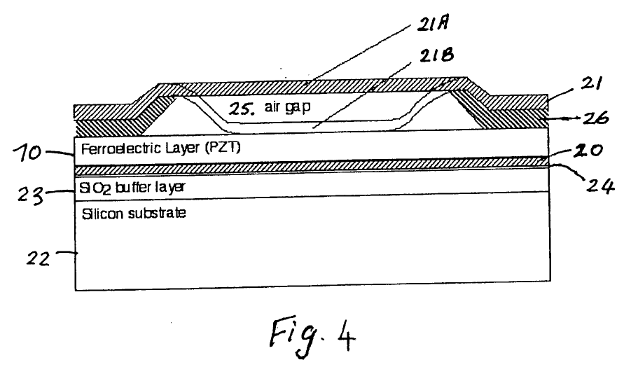

FIG. 4 schematically illustrates the structure of an embodiment of the device according to the invention produced by integrated silicon technology, more specifically by using ferroelectric thin films of the type described in the aforementioned Article “Ferroelectric thin films for micro-sensors and actuators; a review” by P. Muralt. This device comprises a silicon substrate 22 on which is formed an SiO₂ buffer layer 23 coated with a TiOx layer 24 on which is deposited the device's fixed electrode 20 made of platinum, then the ferroelectric layer 10 made in this example of PZT (lead zirconium titanate of perovskite structure). On the ferroelectric layer 10 is placed an insulating structural element 26 e.g. of SiC having a central opening that corresponds to the air-gap 25. This structural element 26 supports a flexible aluminum membrane that forms the movable electrode 21, shown at 21A in its open position and at 21B in its closed position. In the open position the aluminum membrane is held stretched between the edges of the structural element 26, spaced apart from the ferroelectric layer 10. When the first voltage pulse P1 is applied, the central part of the flexible aluminum membrane is elastically deformed into the air-gap 25 to come to apply against the ferroelectric layer 10, as shown at 21B. The device then remains closed as long as zero voltage is applied. When the second voltage pulse P2 is applied, the central part of the aluminum membrane returns to the open position 21A by the resilience of the membrane.

The above-quoted materials are given by way of example and other materials with similar properties can be used. Alternative ferroelectric materials include Strontium Bismuth Oxide, Bismuth Titanates and PZT with partial substitutions including substitutions by niobium, strontium, calcium, rare earths, iron, chromium and lanthanum, amongst others.

This microdevice according to the invention can be used directly as switchable capacitor. The AC signal is conducted through the high capacity of the closed device.

This microdevice according to the invention can also be used as actuator for the actuation of electrical devices, such as electrical DC or RF switches and capacitors. The ferroelectric layer can act as a tunable dielectric.

This microdevice can also serve as optical device such as a position actuator for optical (micro) mirrors and (micro) shutters.

This device can also serve as tunable capacitor in the closed mode when a DC voltage is superimposed to the signal.

For operation of the device, the polarization of the ferroelectric layer 10 does not have to be reversed, but can stay within zero and saturation polarization of one polarity.

The device can serve as a radiofrequency RF switch, where ferroelectricity in the insulating layer is used to increase the capacity and to reduce the electric field across the insulating layer for decreasing the problem of fixed injected charges preventing opening of the switch.

The device can also be used as a memory device.

The device is mainly useful in the micrometer range and can also be useful for macroscopic applications (dimensions up to several mm).

1. A microelectrical device comprising a ferroelectric layer disposed between two generally parallel electrodes at least one of which is movable, the electrodes having a closed position in which the ferroelectric layer is sandwiched between the two electrodes and an open position in which the or each movable electrode is spaced from the ferroelectric layer by a gap, and means for biasing the movable electrode(s) towards the open position, the electrodes being connectable to a voltage source for applying:
a first voltage pulse to move the movable electrode(s) from the open to the closed position against the action of the biasing means,
a low or zero voltage, and
a second voltage pulse of opposite polarity to the first voltage pulse;
such that when the or each movable electrode is moved to the closed position by the application of a first voltage pulse the ferroelectric layer is polarized to hold the movable electrode(s) against the ferroelectric layer, and when said low or zero voltage is applied the or each movable electrode is held in the closed position by remnant polarization of the ferroelectric material until the application of the second voltage pulse which cancels the remnant polarization of the ferroelectric material to allow the movable electrode(s) to be moved to the open position by the action of the biasing means.

2. The microelectrical device of claim 1 which is a capacitor.

3. The microelectrical device of claim 2 which is an RF capacitor.

4. The microelectrical device of claim 1 which is a switch.

5. The microelectrical device of claim 4 which is a bistable switch that remains open or closed as long as no voltage pulse is applied.

6. The microelectrical device of claim 4 which is an RF switch.

7. The microelectrical device of claim 1 which is a position actuator for optical micromirrors or shutters.

8. The micromechanical device of claim 1 which is a micro-relay that actuates another contact for passing a signal current.

9. The micromechanical device of claim 1, which is arranged so that the polarization of the ferroelectric layer is not reversed by application of the first and second pulses, but stays within zero and saturation polarization of one polarity.

10. The micromechanical device of claim 1, comprising a movable electrode made as a resilient flexible membrane that is biased towards the open position by the resiliency of the membrane.
